(19) United States
(12) Patent Application Publication
(10) Pub. No.: US 2006/0075870 A1
(43) Pub. Date: Apr. 13, 2006

(54) Food holder for manual food slicers

(75) Inventors: Eric J. Wangler, Orchard Park, NY (US); Stanley M. Kujawski, East Aurora, NY (US)

Correspondence Address: John C. McMahon, PO Box 30069, Kansas City, MO, 64112, US

(73) Assignee: Eric J. Wangler

(21) Appl. No.: 10/961,248

(22) Filed: Oct. 8, 2004

(51) Int. Cl. B26D 1/00

(52) U.S. Cl. 83/651

(57) ABSTRACT

A food holder or pusher for use with a manual food slicing device having a plurality of nested sections including a base section equipped with a food reservoir and a plunger section equipped with a grip surface having two finger receptacles that are provided to prevent a user's hand from inadvertently slipping off of the grip surface and onto the slicing device.

### BACKGROUND OF THE INVENTION

The present invention is directed to a food holder or pusher for use with a manual food slicing device for domestic and commercial users and especially to such a pusher having superior safety design having finger receptacles that are adapted to accommodate the user's fingers in order to prevent slippage onto a cutting edge of the slicing device.

Devices designed to aid in the slicing of food, particularly meat, fruit and vegetables have long been employed in kitchens throughout the world. The purpose of such slicing devices is to process a bulky unit of food such as a potato by reducing the size and/or shape of the food to facilitate introduction into various recipes and various purposes. Traditional slicers of this nature have at least one cutting blade situated relative to an elevated cutting or slicing surface (sometimes referred to as a mandolin style food slicer) that may or may not be equipped with a pusher.

The pusher disclosed herein is designed to fit a conventional style slicer or alternative designs and can be sold with a food slicer or sold separately as an after-market upgrade option for use with a food slicer in order to accommodate users desiring heightened safety.

In the design of food slicers, it is important to recognize that such slicing devices are likely to be used domestically and in the home by non-professionals, which includes but is not limited to children who may not be familiar with the device, aware of the dangers presented from misuse and/or even recognize what is proper use and misuse. The present invention is designed to provide an additional measure of safety for those using manual slicers in that the fingers of the hand of the user are hidden, protected, covered or otherwise distanced away from the object being sliced and essentially away from the cutting structure that effects the slicing. Traditional pushers require the user to grip the pusher with one hand and drive it up and down the cutting surface while securing the slicer with a support grip that is located on the frame. A shortcoming of traditional pushers is that the user's fingers are exposed to the cutting blade or blades, because the fingers are located on the outside surface of the pusher and are prone to slip off of the grip and onto the cutting surface or the user becomes careless and grasps the pusher too low so that fingers engage or eventually engage a sharp cutting edge as the food is sliced, thus resulting in user injury, which becomes more likely to happen as the pusher becomes wet with juices that are emitted from the subject food.

Therefore, it is ideal to employ a pusher with a design that prevents a user's fingers from slipping off of the pusher or being initially placed in harm's way by placement in a protected cavity. Furthermore, it is ideal to have a pusher that remains relatively clean without collecting debris to deter the possibility that the device will require frequent cleaning, thus minimalizing the maintenance required during operation and essentially reducing the possibility of inadvertent contact with cutting surfaces during disassembly and, thus, lowering the likelihood of injury.

Therefore, there is a need to provide a pusher that is designed to provide operators with an improved gripping system to avoid inadvertent slipping off the face of the pusher and initially places the fingers in a protected location.

### SUMMARY OF THE INVENTION

The present invention addresses the need to improve the design and safety of manual thin-cutting devices and especially the design of food holders or pushers associated with such devices and provides a pusher having a grip equipped with finger-bores having opposable-grip surfaces. The pusher secures the food in an interior cavity and is designed to jog up and down a ramp having a cutting blade. The finger bores are provided to allow the user to manipulate the pusher and prevent injury by preventing inadvertent slippage off the grip surface and onto the ramp and cutting blade. The position of the hand on the improved pusher also provides better control of the pusher, allows the user to maintain even downward and forward force on the food so that sliced food has a generally uniform thickness and allows both the thumb and the other fingers to grip the pusher firmly therebetween. The pusher also provides a large and very stable surface area that contacts the food and is fixedly attached to an upper telescopy position of the pusher, so that the pusher is capable of receiving a large volume of food that is pushed downwardly by the strong and secure food engaging surface.

### OBJECTS AND ADVANTAGES OF THE INVENTION

Therefore, the objects of the present invention are: to provide a food holder or pusher for use with manual food slicers with the pusher equipped with finger receptacles to prevent inadvertent slippage off the pusher and onto the cutting surface resulting in user injury; to provide such a pusher equipped with finger receptacles in order to provide heightened control and to provide better protection to the fingers of the user; to provide such a pusher that remains relatively clean without collecting debris; to provide such a pusher designed to promote ease of cleaning and maintenance; to provide such a pusher having a universal size and shape that can be employed with a variety of manual food slicers; to provide such a pusher having an expandable size and shape that can be employed with a variety of food sizes and shapes; to provide such a pusher that is designed to provide a safer manual food slicer, thus deterring user injury; to provide such a pusher that is easy to use, relatively inexpensive to produce and especially well adapted for the intended usage thereof.

Other objects and advantages of this invention will become apparent from the following description taken in conjunction with the accompanying drawings wherein are set forth, by way of illustration and example, certain embodiments of this invention.

The drawings constitute a part of this specification and include exemplary embodiments of the present invention and illustrate various objects and features thereof.

### BRIEF DESCRIPTION OF THE DRAWINGS

FIG. 1 is a side elevational view of a food holder or pusher mounted on a manual food slicer in a compressed configuration.

FIG. 2 is a perspective view of the pusher with a base portion and lower and upper plunger portions that are exploded in order to show detail.

FIG. 3 is an exploded perspective view of the pusher.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

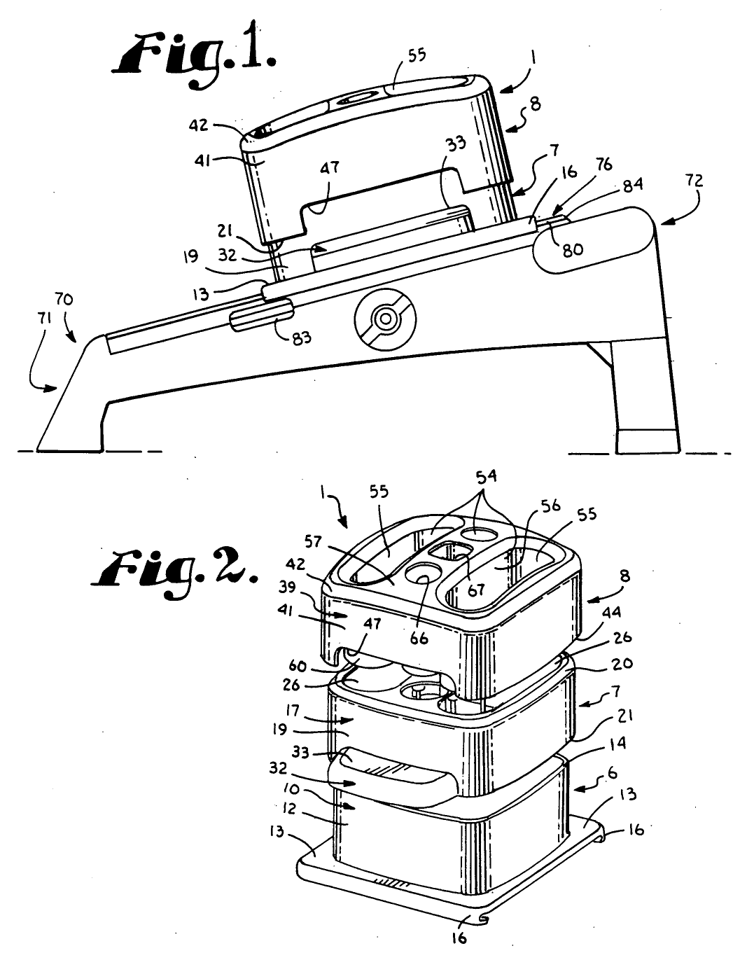

The reference number 1 generally represents a food holder or pusher in accordance with the present invention and as depicted in FIGS. 1-3. The pusher 1 primarily consists of a base portion 6, a lower plunger portion 7 and an upper plunger portion 8 that are sized and shaped to slidably fit in succession on the outside of and nest within each other to form a nested and compressed configuration as depicted in FIG. 1.

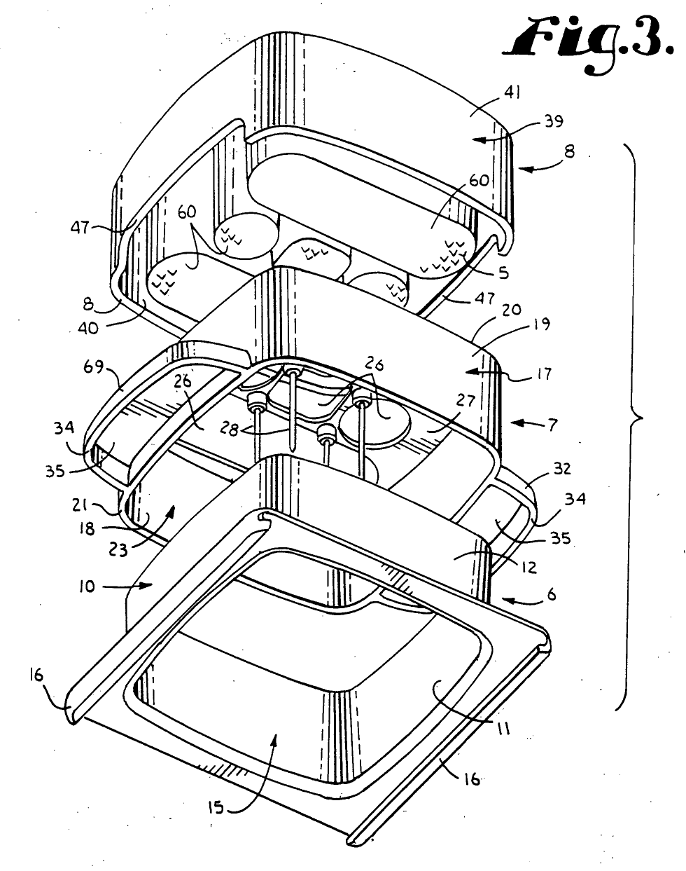

The base portion 6 has an upstanding perimeter wall 10 with inner and outer surfaces 11 and 12 that have a generally rectangular shape with radiused or rounded corners. The wall 10 joins with a lower lip or shoulder 13 that protrudes generally perpendicularly outwardly from near a bottom of the wall 10, as shown in FIGS. 2 and 3. On the underside of the shoulder 13 are a set of facing slots or track receivers 16, which are situated on opposite sides of the base portion 6. The wall 10 has an upper edge 14 opposite to the lower shoulder 13, which divides the inner and outer surfaces 11 and 12. The perimeter wall 10 encompasses an inner cavity 15 that operably receives food (not shown).

The lower plunger portion 7 has a perimeter wall 17 that is sized and shaped to be slidingly received over the perimeter wall 10 of the base portion 6 having a similar height but a slightly larger width and length so as to allow the base portion 6 to nest inside of the lower plunger portion 7. The perimeter wall 17 of the lower portion 7 has inner and outer surfaces 18 and 19. At the top and bottom of the wall 17 are upper and lower edges 20 and 21, with the upper edge 20 including a chamfered or beveled edge that meets a top surface 22.

The top surface 22 has a plurality of apertures 26 that open into an inner cavity 23, which will be discussed further below. The top surface 22 has an underside 27 with four downwardly projecting food engaging spikes 28 that project into the cavity 23 and are designed to penetrate and secure food. At the base of the lower portion 7 are two outwardly extending handles 32 that extend outward from the base of the wall 17. The handles 32 have upper support surfaces 33 and lower surfaces 34 that are adjacent to the lower edge 21. Each handle 32 has a lower recess 35 that provides heightened gripability to a user. The handles 32 allow a user to firmly grip the lower portion 7, so as to allow the user to push harder on the upper portion 7 when food is being impaled on the spikes 28.

The upper plunger portion 8 is similarly shaped to the base and lower portions 6 and 7 having a perimeter wall 39 that is the sized and shaped to be slidingly received over the wall 17 with the wall 39 being of generally the same height, but having a slightly larger width and length than the wall 17 of the lower portion 7 so that the lower portion 7 can slide into the upper portion 8. The perimeter wall 39 has inner and outer surfaces 40 and 41 that are opposite to each other. At the top of the wall 39 is a chamfered or beveled edge 42 that corresponds to the beveled edge 20 of the lower plunger portion 7, as depicted in FIG. 2. The edge 42 joins the wall 39 with an upper surface 43. At a base of the wall 39 is a lower shoulder 44 with opposed grooved portions or slots 47. Each slot 47 is shaped to be received over a respective handle 32 and provided so that when the upper plunger portion 8 mates with and nests over and around the lower plunger portion 7, the handles 32 slide into the slots 47 enabling the upper portion 8 to completely envelope the lower portion 7.

The upper surface 43 of portion 8 has a plurality of downwardly projecting receptacles 54 with height approximating that of the wall 39. Two of the receptacles are finger receiving receptacles 55 having opposable grip surfaces 56 that are separated by a central portion 57, as depicted in FIG. 2. The receptacles 55 are alternatively usable depending on which way the pusher 1 is mounted. That is, the opposable grip surfaces 56 are sized and shaped to receive the fingers of a hand depending on which side is to the front (left is to the front in FIG. 1) with the palm of the hand on the back side of the surface 43. Placement of the fingers into the front receptacle 55 prevents inadvertent slippage off of the pusher 1 and onto a manual food-slicing device 70 and further provides heightened gripability to aid in maneuvering the pusher 1. Normally, the thumb is simultaneously received in the rear cavity 55 with the remaining fingers in the front cavity 55. In this way, all are protected and can advantageously grasp the structure or sides of the wall formed therebetween.

It is foreseen that the receptacles 55 could be equipped with apertures for draining debris and/or juices that become trapped within the receptacles 55 during use in order to deter build-up, which could disrupt the slicing operation forcing the user to stop and intrinsically clean the pusher. Between the receptacles 55 are other receptacles 66, 67 and 68 which have approximately the same height as the wall 39. While two cylindrical shaped and one central square shaped receptacles 67, 66 and 68 receptively are shown, it is foreseen that there could be of various shapes and simply provide a lower surface or footprint in conjunction with the bottom of the receptacles 55 to engage the food. In particular, the receptacles 54 have a series of lower or bottom sides that join to form an substantial lower surface or ram 60 that depends from the upper surface 43, so that when the upper portion 8 is mounted onto the lower portion 7, the ram 60 matingly passes through the plurality of apertures 26 located on the top surface 22 of the lower plunger portion 7.

The ram 60 is designed and situated in such a manner so as to coordinate with the spikes 28 for holding and urging food (not shown) relative to the slicer 70. Specifically, the receptacles 54 that space the ram 60 from the surface 57 are of approximately the same length as the spikes 28 so that, as the upper and lower portions 7 and 8 telescope with respect to each other and to the base portion 6, the relative position of the ram 60 and spikes 28 vary. When more food is in the pusher 1, the ram 60 spaces upwardly and as the food is sliced, the ram 60 moves toward the slicer 70 and the ram 60 becomes closer to ends of the spikes 28. In use, the ram 60 motivates food downward so that when the upper portion 8 is fully nested onto the lower portion 7 and the upper edge 42 of the upper portion 8 engages the corresponding upper shoulder 20 of the lower portion 7, the ram 60 extends to near the end of the spikes 28. To heighten friction with the food, the ram 60 has a food-engaging abrasive surface 62.

In the nested configuration, the three portions 6, 7 and 8 form the pusher 1. The pusher 1 is designed to slide from front to rear or traverse the food slicer 70 having front and rear ends 71 and 72. The slicing device 70, as depicted in FIG. 1, is equipped with a sloped ramp surface 76 with a blade cartridge 83 (the handle of which is seen) having a cutting edge (not shown) that faces the rear 72 of the slicer 70. The track receivers 16 that are located on either side of the base portion 6 are sized and shaped to be received on and ride along corresponding tracks 80 of the slicing device 70. It is foreseen that the pusher tracks could be adjustable or otherwise designed to accommodate a plurality of slicer designs.

Mounting of the base portion 6 over the ramp surface 76 is achieved by aligning either end of the track receivers 16 with ends 84 of the tracks 80, which are located at the rear end 72 of the slicer 70. The engagement of track receivers 16 and 80 provides guidance for the pusher 1 and ensures that the pusher 1 remains above the ramp surface 76. Mounting is ideally achieved by disengaging the base portion 6 from the lower and upper plunger portions 7 and 8. Once the base portion 6 is mounted over the ramp surface 76, the base portion 6 acts as a food receptacle allowing the user to place the subject food (not shown) within the cavity 15 of the base portion 6.

The lower plunger portion 7 is then nested onto or telescopingly received on and around the base portion 6 so that spikes 28 penetrate and engage the subject food within the base portion 6 during use. The handles 32 are provided on either side of the lower plunger portion 7 to facilitate positioning.

Once the lower portion 7 is positioned on and nested with the base portion 6 and the subject food is secured therein, the upper plunger portion 8 is placed over the lower plunger portion 7. To fit the portions 7 and 8 together, the ram 60 with its different components is aligned with the apertures 26 and lowered downward causing the rough surface 62 to bite into the food. Downward pressure provided by the user pushes or urges the food toward and against the ramp surface 76 of the slicing device 70. Once the food is trapped between the teeth 62 and ramp surface 76, the food is positioned for slicing. It is foreseen that the upper and lower portions 7 and 8 may be initially assembled at the factory so as to be permanently joined together.

To slice the subject food, the user moves the pusher assembly 1 back and forth on the ramp surface 76 by placing the fingers of one hand in one of the finger receptacles 55 that are located on the upper plunger portion 68, preferably the one closer to the front or to the left in FIG. 1. Gripping in this manner provides heightened control and most importantly, prevents the user's fingers from slipping out of the receptacle 55 and onto the ramp surface 76 or into the blade of the cartridge 83. Depending on the desired position of the user, either receptacle 55 can be used interchangeably. It is foreseen that the receptacles 55 may be designed with finger ribs and grooves for heightened gripability. This feature provides for improved safety.

In use, the user positions the food within the cavity 15 of the pusher 1, which is secured by the spikes 28 that penetrate the subject food. The pusher 1 is positioned initially toward the rear end 72 of the ramp 76 and is slid downward toward the front end 71 and against the cutting edge of the blade in the cartridge 83 causing a sliced food portion to fall below the ramp 76 with any remaining portion retained in the pusher 1. As the food is sliced, the initial food unit becomes smaller and in order to maintain the desired cut, the toothed and rough food-engaging surface 62 of the pusher 1 is urged downward by the user by pushing against the upper plunger portion 8. The limit of movement of the spikes 28 and ram 60 is just above the slicer surface 76. The food is sliced until either the user obtains a desired amount of sliced food or the remainder portion of the food is depleted.

It is to be understood that while certain forms of the present invention have been illustrated and described herein, it is not to be limited to the specific forms or arrangement of parts described and shown.

What is claimed and desired to be secured by Letters Patent is as follows:

1. A food holder adapted for use with a slicer, comprising a plurality of sections having:
a) a base section with a food reservoir; and
b) a plunger section with a grip surface having a finger receptacle slidably and telescopingly mounted with respect to said base section.

2. The food holder as in claim 1 wherein:
a) said finger receptacle has a lower food engaging footprint.

3. The food holder as in claim 1 wherein:
a) said holder has a pair of finger receptacles that are situated opposite to each other.

4. The food holder as in claim 1 wherein:
a) said finger receptacle is sized and shaped to receive the fingers of one hand an provide an ergonomic inner surface for heightened gripability.

5. The food holder as in claim 1 wherein:
a) said plunger section has a lower and an upper plunger section.

6. The food holder as in claim 5 wherein:
a) said lower plunger portion includes of a set of food engaging spikes.

7. The food holder as in claim 6 wherein:
a) said upper plunger portion includes said grip.

8. The food holder as in claim 1 wherein:
a) said lower section includes opposed track receivers adapted to be received on tracks of a slicer.

9. In a food holder for a food slicer, the improvement comprising:
a) a receptacle sized and shaped for receiving the fingers of a hand to protect the fingers from injury during usage.

10. In a food holder for a food slicer, the improvement comprising:
a) a unit with a nested and telescoping first section, second section and third section;
b) said first section including track structure adapted to be slidably mounted on a slicer;
c) said second section mounted over said first section and including spikes adapted to engage food during usage; and
d) said third section mounted over the second section and having inner projections that provide a ram surface that projects into said first and section sections and is adapted to operably engage food during usage.

11. The holder according to claim 10 wherein:
a) said third section includes a receptacle adapted to operably receive the fingers of a user during usage thereof.
